(19) United States
(12) Patent Application Publication
(10) Pub. No.: US 2020/0342427 A1
(43) Pub. Date: Oct. 29, 2020

(54) Decentralized Settlement Of A Service Using A Distributed Ledger

(71) Applicant: SAP SE, Walldorf (DE)

(72) Inventor: Raik Kulinna, Wiesloch (DE)

(21) Appl. No.: 16/394,993

(22) Filed: Apr. 25, 2019

(51) Int. Cl. G06Q 20/10; G06Q 30/04; H04L 9/06; G06Q 20/40

(52) U.S. Cl. CPC G06Q 20/102; G06Q 20/4014; H04L 9/0637; G06Q 30/04

(57) ABSTRACT

[symbol]

selects a record in a distributed ledger indicating that a user used a service offered by a second service provider where the record includes a first user identity for the user. The first user identity is mapped to a second user identity. The method creates a first invoice for the second user identity including a first charge for using the service based on information in the record of the distributed ledger and receives a second invoice from the second service provider including a second charge based on the user using the service. The second invoice is received outside the distributed ledger and includes a service provider identity and the first user identity. A purchase order is created for the second invoice from the second service provider to settle the second charge and the first charge for the user using the service.

### BACKGROUND

The energy market allows users to charge their vehicles using a home utility. For example, the utility that provides power to the user's home is typically the user's home utility. However, artificial borders to the user occur when the user is not using their home utility, such as when the user is charging his/her electric vehicle in a neighboring town operated by a different utility, charging his/her electric vehicle in the same town but the charging station operator is not collaborating with the user's home utility, or combining charging with car-sharing among multiple users.

The artificial borders may be overcome using intermediaries that operate between the home utility and the user. However, this exposes information about the user to the intermediaries. Further, some intermediaries may gain unnecessary market power over utilities due to the necessity of their existence and the intermediaries may charge the users higher rates. Users may not be able to avoid the higher charges because utilities may not be able to provide a solution to users without using the intermediaries.

### BRIEF DESCRIPTION OF THE DRAWINGS

FIG. 1 depicts a simplified system for using a distributed ledger to provide settlement of services according to some embodiments.

FIG. 2 depicts an example of a registration process according to some embodiments.

FIG. 3 depicts a flowchart of a method for processing the service according to some embodiments.

FIG. 4 depicts a simplified flowchart of a method to settle invoicing and payment for the service outside the distributed ledger according to some embodiments.

FIG. 5 illustrates hardware of a special purpose computing machine configured with a billing service according to one embodiment.

### DETAILED DESCRIPTION

Described herein are techniques for a decentralized clearing system. In the following description, for purposes of explanation, numerous examples and specific details are set forth in order to provide a thorough understanding of some embodiments. Some embodiments as defined by the claims may include some or all of the features in these examples alone or in combination with other features described below, and may further include modifications and equivalents of the features and concepts described herein.

A system uses a distributed ledger, such as a blockchain, to allow users to receive services that are offered by a third party service provider different from the user's home service provider. Using the distributed ledger eliminates intermediaries when a third party service provider provides the service to the user that is associated with a home service provider. In some embodiments, the service may be involve providing some type of power, such as electricity, to a user. For example, a user may have an electric vehicle that requires charging. Although charging of electric vehicles will be described, other types of services may be used, such as any type of service that is currently using an intermediary between two different service providers may be used. For example, the service may be charging of other products, such as for fees associated with car parking.

Using the distributed ledger, the identities of users may not be provided to the third party service provider or entities. Rather, an anonymous identity may be created for the user and stored in a first distributed ledger that stores identities for users. When the user uses a third-party service, a summary of the services provided to the anonymous identity may be stored in a second distributed ledger that stores summaries of services provided to users. The home service provider can scan the second distributed ledger and determine the charges for the service provided. The home service provider can then map the anonymous identity to an actual user identity that can be used to identify the user. Further, the third party service provider may send an invoice for the service to the home service provider. Using the user's identities, the home service provider can invoice the user and also create a purchase order for the service provider's service. The invoicing of the user and the invoice/purchase order for the third party service provider may be performed outside the distributed ledger (e.g., a Directive 2014/55/EU compliant elnvoice with anonymous identity as reference; not on the distributed ledger/off-chain) to maintain the privacy of the user and the third party service provider. Additionally, the settlement of invoices outside the distributed ledger may avoid intermediary fees, such as fees for using a distributed ledger to transfer monetary amounts of currency. Accordingly, the use of the distributed ledger with settlement of charges outside the distributed ledger protects the privacy of users while allowing services of third party service providers to be used without using intermediaries.

System Overview

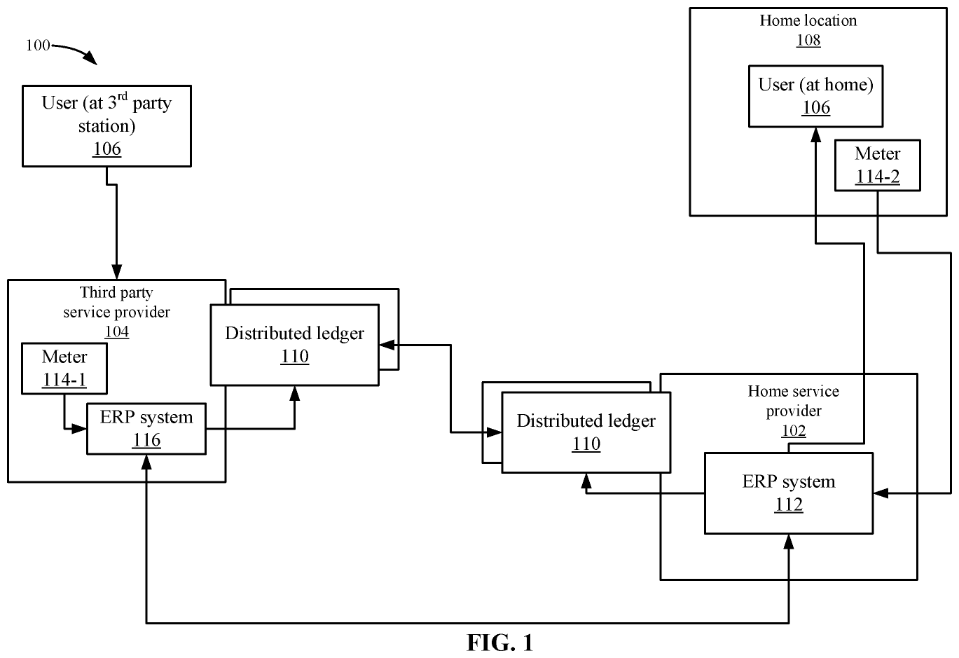

FIG. 1 depicts a simplified system 100 for using a distributed ledger to provide settlement of services according to some embodiments. System 100 includes a home service provider 102, a third party service provider 104, a user 106, and a distributed ledger 110. Home service provider 102 may be a first service provider that provides a service to user 106. In some embodiments, the service may include providing power (e.g., electricity, or another type of services) to the user. For example, the user may have an electric vehicle (or other type of product) that the user charges using the service provided by home service provider 102.

In some examples, home service provider 102 may provide the service to user 106 at a home location 108. Home location may be a specific location associated with user 106 (e.g., a user's primary residence, workplace, etc.). Home service provider 102 may provide service to the user in a limited geographic area, such as only at the user's home, in a town or other geographic border, at certain charging stations, etc. Home service provider 102 also has a relationship with the user and can invoice the user for services.

Third party service provider 104 may also provide a service to user 106, such as providing power to a product owned by user 106. Third party service provider 104 is a second service provider that is different from home service provider 102, such as third party service provider 104 and home service provider 102 are different companies. However, similar to home service provider 102, third party service provider 104 may be providing power to an electric vehicle for user 106. But, third party service provider 104 may be providing the service outside of the user's home location 108, such as at a charging station or another location. Also, the charging station may be outside of the home service provider's network and thus the third party service provider 104 may be providing the service instead of home service provider 102. Third party service provider 104 may not have a pre-existing billing arrangement with user 106.

Distributed ledger 110 is described, which may include a distributed copy of the ledger in one or more versions of the distributed ledger. Each version may duplicate the information described. For example, a distributed ledger 110 may be a consensus of replicated, shared, and synchronized data that may be spread across multiple locations. Blocks are replicated across nodes storing distributed ledger 110 based on consensus algorithms that verify that a correct copy of a record is stored in distributed ledger 110. The data in distributed ledger 110 may be stored in records that are in the form of blocks. There may be no centralized administrator or centralized data storage of a distributed ledger 110. Distributed ledger 110 is also public and records in the distributed ledger 110 may be viewed by anyone. When distributed ledger 110 is described, any of the versions may be referenced. Also, although a single distributed ledger is described that combines identity and transaction information together, the identity and transaction information may be separated on different ledgers.

Distributed ledger 110 may be an identity distributed ledger that is used to store identities for the users and third party service providers 104. The identity stored in distributed ledger 110 for the user 106 may be an anonymous identity. Also, the identity stored for third party service provider 104 may be an anonymous identity for the third-party. An anonymous identity may be an identity that is not associable with user 106 without a mapping from the anonymous identity to an actual user's identity. The actual user's identity can be used to contact the user for billing purposes. Home service provider 102 may include an enterprise resource planning (ERP) system 112 that can create an anonymous identity for a user. Home service provider 102 may sign the identity (e.g., with a cryptography key) to verify the authenticity of the identity and then stores the anonymous identity in distributed ledger 110. Further, ERP system 112 may privately store the mapping of the anonymous identity for the user to the actual user's identity that was created by home service provider 102.

Distributed ledger 110 may store records of the services that are provided to users. The records may include the anonymous identifiers for users and third party service provider 104. Blocks in distributed ledger 110 may be used to store information for the services, such as a timestamp, fees, an anonymous identity, and the identity of third party service provider 104.

Meter 114-1 and meter 114-2 are used to measure the service provided to user 106. For example, meter 114-2 is used at home location 108 to measure the service provided to user 106 at home by home service provider 102. For example, home service provider 102 may measure the amount of power that is used to charge an electric vehicle. Meter 114-1 may be used at a third-party station to measure the service provided by third party service provider 104. For example, third party service provider 104 may use a meter 114-1 to track the amount of power used to charge the electric vehicle of user 106.

Enterprise resource planning (ERP) system 116 or a similar procurement system may be used to record the service provided to user 106 and the anonymous identity that was used by third party service provider 104. ERP system 116 may also be used to insert information (e.g., in a block) in distributed ledger 110 with information for the service provided by using the anonymous identity of user 106. Further, ERP system 116 may be used to invoice home service provider 102 for the service for user 106 along with fees from any other users with the reference to the anonymous identity of user 106.

ERP system 112 for home service provider 102 may be used to invoice user 106. For example, ERP system 112 invoices user 106 for the use of services at home location 108. Additionally, ERP system 112 may receive entries from the distributed ledger 110 with the anonymous identify of user 106 for services provided to user 106 (and other users). Then, ERP system 112 coordinates invoicing of user 106 for services used at home location 108 (consumed either anonymously or using a known identity to ERP system 112) and services at third party service provider 104 that were consumed with the anonymous identity of user 106. Further, ERP system 112 generates a purchase order for third party service provider 104 for the service provided to user 106 (and other users) to settle payment for charges with third party service provider 104 that were incurred by the user (and other users). The settlement is outside distributed ledger 110 to avoid fees associated with using an intermediary or a distributed ledger. The settlement is done based on the anonymous identity of user 106 such that third party service provider 104 does not know the identity of user 106 during the whole process.

The following stages in the process will now be described: a registration process, a service process, and a billing process using the above elements in system 100 according to some embodiments.

Registration Process

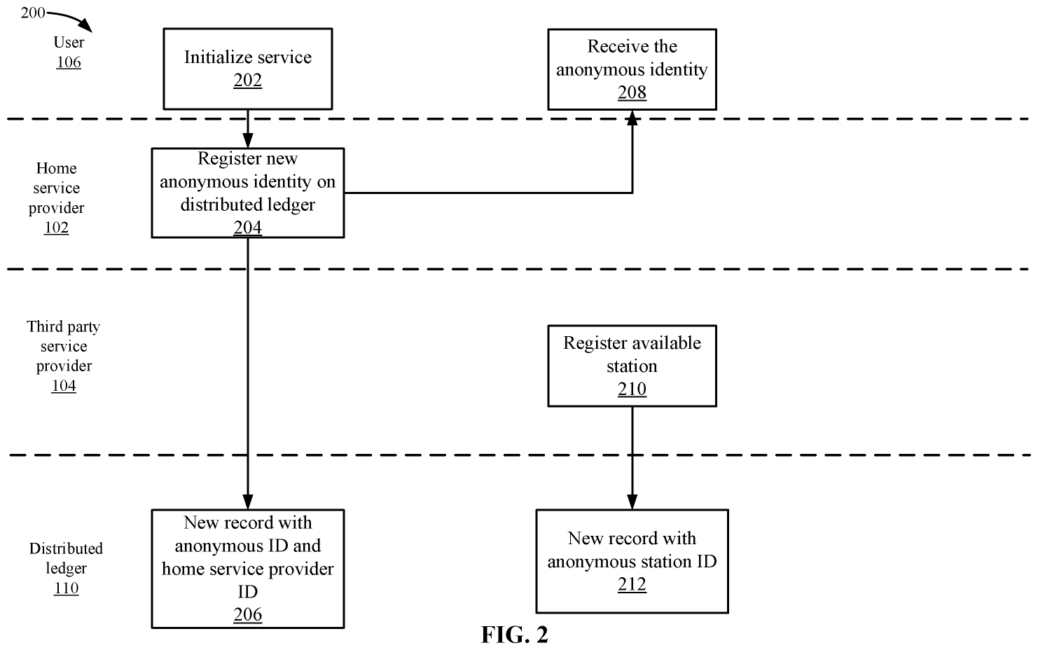

FIG. 2 depicts an example of a registration process according to some embodiments. User 106 and third party service provider 104 may register to create anonymous identities that can be used in distributed ledgers 110.

At 202, user 106 initializes a service with home service provider 102. For example, a user may purchase electric vehicle products, such as a wall box, and have the products installed. The user may also initiate a service in other ways, such as establishing a service with home service provider 102 in which the user can roam to other service providers to receive charging services. At 204, home service provider 102 creates and registers a new anonymous identity for user 106 on distributed ledger 110. The new identity may be an anonymous identity for user 106 because distributed ledger 110 is a public ledger that can be accessed and seen by anyone. The anonymous identity may be used for privacy reasons. Although the anonymous identity is described, identities that are not anonymous may also be used. To validate the identity, home service provider 102 may sign the anonymous identity with a private key of home service provider 102. The identity may later be validated using the public key in an asymmetric cryptography system.

At 206, distributed ledger 110 stores a new record in a block that includes the anonymous identity and an identity for home service provider 102. The new record may be stored when nodes verify and agree on the authenticity of the record. Other information may also be included. For example, the block may include an address for home service provider 102, the anonymous identity for user 106, authentication information for user 106, an end-date validity, and an invoicing method. The anonymous identity may be authenticated using a public key that corresponds to a private key provided to user 106 or the anonymous identity is a public key from a cryptography system. That means the anonymous identity can be verified by anyone with the public key of the associated home service provider 102. Furthermore, the public key of the anonymous identity of user 106 is signed so that the private key of user 106 can be used in trusted identification methods on third party service providers such as third party service provider 104.

The private key can be verified with the public key of user 106 that is stored in the distributed ledger 110 or stored in a public key infrastructure. The public key of user 106 can be verified over the account management (user management) of the distributed ledger or an additional signature signed with a private key of the home service provider 102. The public key of home service provider 102 may be included in the distributed ledger 110 or may be stored outside in a public key infrastructure.

Therefore, third party service provider 104 can trust that the consumed services can be invoiced to home service provider 102 without knowing the real identity of the user 106 and therefore without knowing private information of the user 106. The anonymous identity may be embodied in a distributed ledger 110 that stores the anonymous identity. Also, distributed ledger 110 may also include the public key that is assigned to the user for the authentication if the account management of distributed ledger 110 is not trusted enough and if no parallel public key infrastructure is used. The validity end-date may set a time in which the anonymous identity should expire and the invoicing method may indicate how to invoice user 106.

At 208, user 106 receives the anonymous identity and that anonymous identity can be used at third party service providers such as third party service provider 104. For example, the anonymous identity and its private key may be embodied in a physical medium, such as a radio frequency identity (RFID) card, a cryptography chip in the car or in the charging cable, or another type of product that can be used to store the anonymous identity and that can communicate with the charging station. As discussed above, the distributed ledger 110 may also include the public key that is assigned to the anonymous identity and that was signed by home service provider 102

At 210, third party service provider 104 may also register an available charging station and the corresponding parking spaces. The available station may be a location in which user 106 can receive other services from third party service provider 104, such as fee-based parking.

At 212, upon registration, distributed ledger 110 stores a new record for third party service provider 104 with the available station identity. The available station identity may be an anonymous identity for the station, but in other embodiments, the station identity may not be anonymous. The anonymous station identity may not be associated with third party service provider 104 without a mapping to an actual third party identity that is stored by ERP system 116. In some examples, the block in distributed ledger 110 may include an address for third party service provider 104, an identity for the charging station, authentication information for the charging station, geo-location coordinates for the charging station, and a payment method. The authentication information may be a trusted account in distributed ledger 110 or additionally a public key that is used to check the validity of the stored transactions.

Distributed ledger 110 may include the public key or a public key infrastructure is used for the keys. The geo-location coordinates may be the geo-coordinates where the station is located; and the invoicing method may be how to remit payment to third party service provider 104. Additionally, the record may also include information for service charges, such as the charging prices that are charged for the service, the availability of the charging station, parking charges, etc.

Accordingly, distributed ledger 110 includes an anonymous identity for user 106 and an available station identity for third party service provider 104. Distributed ledger 110 may include multiple identities for multiple users in addition to multiple available station identities for multiple stations.

Service Processing

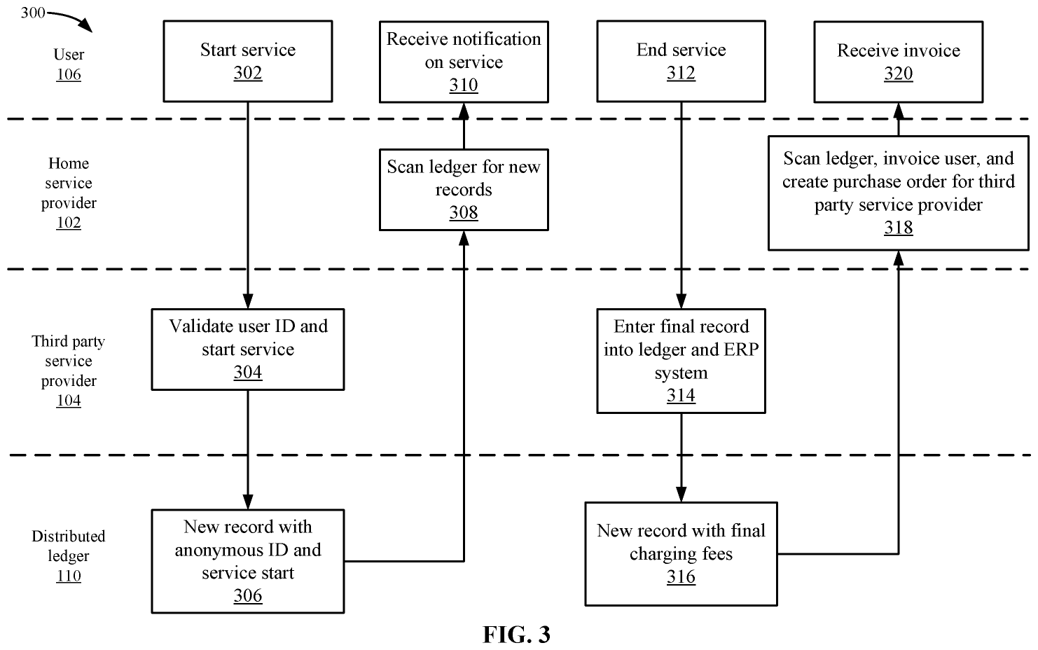

User 106 may have a service performed by third party service provider 104. FIG. 3 depicts a flowchart 300 of a method for processing the service according to some embodiments. At 302, user 106 starts the service at a third-party charging station associated with third party service provider 104. For example, user 106 may travel to a location for the third-party station. Then, user 106 starts the service, such as by connecting the user's electric vehicle to the third-party charging station.

At 304, third party service provider 104 may validate the user identity and start the service. Validating the user identity may involve validating an identity card for user 106, such as using a private key inside an RFID card or a cryptography chip in the car or a cryptography chip in the charging cable. The ownership of the private key can be validated by the public key in the record of the distributed ledger 110 or indirectly over the public key in an external public key infrastructure. Also, third party service provider 104 may look up the user anonymous identity in distributed ledger 110. Once finding an entry with the anonymous user ID for the user 106 in distributed ledger 110, third party service provider 104 can also determine the identity for home service provider 102, which may be the billing company stored in the block in distributed ledger 110. The identity for home service provider 102 may be used later when third party service provider 104 invoices home service provider 102 for the charging services and other services performed by user 106. Once validating the anonymous user identity and determining the identity of home service provider 102, third party service provider 104 can provide the service to user 106 without having to directly charge user 106 and without getting details about the private identity of user 106. This may be convenient for the user to have all invoices for charging be received from home service provider 102. Furthermore the user 106 does not need to directly use any payment method at third party charging station 106. This simplifies the security requirements in the charging hardware while making charging very user friendly for user 106.

At 306, distributed ledger 110 stores a new record in distributed ledger 110 with the anonymous identity of user 106 that indicates a service start for the service. As the service proceeds, additional records may be stored that track the progress of the service. For example, any updates or changes to the service may be recorded in distributed ledger 110.

At 308, home service provider 102 may scan distributed ledger 110 for new records. When a new record for a service start is found for user 106, home service provider 102 may map the anonymous identity to the user identity for user 106. Home service provider 102 scans distributed ledger 110 at certain intervals and can determine the service start time and any updates without having to be notified directly by an intermediary.

Once detecting the record for the start of the service with third party service provider 104, at 310, home service provider 102 sends a notification to user 106 indicating the start of the service and user 106 receives the notification, such as on an application. User 106 then performs the service, such as charging the user's electric vehicle, and at 312, user 106 ends the service. Third party service provider 104 may store the charging information in blocks of distributed ledger 110. For example, charging information may be stored in small chunks in distributed ledger 110 as the charging proceeds.

At 314, third party service provider 104 receives the end service notification and enters a final record into distributed ledger 110 and ERP system 116 or an equivalent procurement system. At 316, distributed ledger 110 stores a new record in a block with the final charging fees. The new record may include a station identity for the third-party station, a station name (e.g., a readable address for the station), an identity for third party service provider 104, and a station signature so that home service provider 102 can verify the validity of the record. Also, the record includes the anonymous identity for user 106. The station signature may be used to prove the validity of the record. The charging fees may also include the charging start time, the charging end time, a meter value start time, a meter value end time, the consumed energy, the cost of the service, and others. Additionally, a service completed field may also be set indicating that the service has been completed. The charging information may include the start and end time, but not in all cases, the actual pricing. However, ERP system 116 may include the pricing for the service such that the pricing information remains private and final discounts can be negotiated between third party service provider 104 and home service provider 102. Alternatively, the record may store the pricing or the pricing may be stored in distributed ledger 110 in the record for the available station identity.

As home service provider 102 scans distributed ledger 110 for records, home service provider 102 finds a record with the charging fees for user 106 claimed by third party provider 104. Then, home service provider 102 aggregates any records for the user that are associated with the service for invoicing over the ERP system 112. Home service provider 102 scans distributed ledger 110 at certain intervals and can determine the service end without having to be notified by an intermediary, such as by scanning for a block with the service end flag. Home service provider 102 can verify the charges are valid trusting the accounts in the distributed ledger 110 or if additional signatures of third party service provider 104 are used then using the public key of third party service provider 104. The public key of third party service provider 104 may have been stored in distributed ledger 110 or in an external public key infrastructure and used to verify the claimed fees with this additional authentication. Such additional authentication may be used if distributed ledger 110 is less trusted and account identity doesn't provide implicit trusted information.

Either the account information or additional signatures with a private key by third-party service provider 104 enables home service provider 102 to verify that the record for the consumed service and the claimed fees are correct and can be trusted. As a result, third party service provider 104 can trust the anonymous identity of user 106 plus identity of home service provider 102 and in the end can trust the distributed ledger 110, which means third party service provider 104 can trust that the services consumed by user 106 will be paid by home service provider 102 without knowing the real identity of user 106 and without requesting a payment directly from the user 106.

The records are transferred from distributed ledger 110 in FIG. 3 to ERP system 112 of home service provider 102. At 318, ERP system 112 can combine fees from third party service providers with other fees from home service provider 102 into a single invoice for a time period. Then, at 320, user 106 receives an invoice from home service provider 102. In this example, the invoice is received from home service provider 102 instead of third party service provider 104. This preserves the anonymity of user 106 in front of the services of third-party services providers 104 as well as allowing consumption without any other payment method.

Also at 318, home service provider 102 also creates a purchase order for third party service provider 104. The purchase order is used to remit payment to third party service provider 104 for providing the service to user 106. This means this purchase order is used for paying the third party service provider for the consumed services of the user 106.

Settlement of Charges Outside the Distributed Ledger

The settlement of charges for the service may be resolved outside the distributed ledger 110, for example with help of a directive 2014/55/EU compliant elnvoice. That is, the invoicing of user 106 and the payment to third party service provider 104 may not be recorded in distributed ledger 110. The invoicing and payment for the service may be resolved outside the distributed ledger to preserve privacy for user 106 and/or third party service provider 104 and also to avoid any additional transaction fees of external payment service providers. On the other hand, payment specific legislation could be avoided in distributed ledger 110 because final payment is performed using ERP system 116 or a similar procurement system and on the other side with the billing system 112.

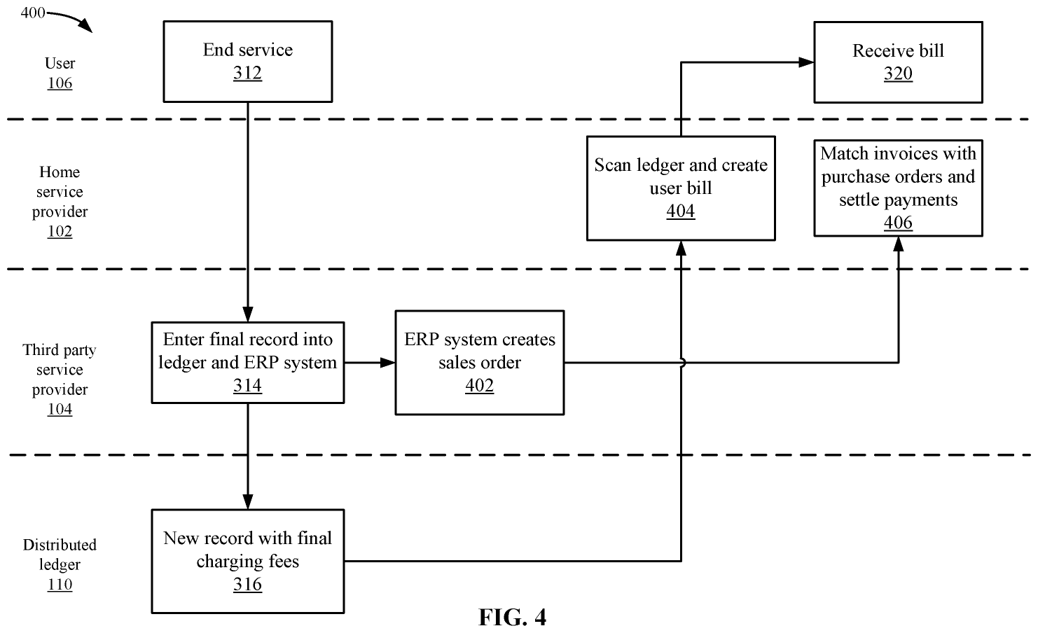

FIG. 4 depicts a simplified flowchart 400 of a method to settle invoicing and payment for the service outside distributed ledger 110 according to some embodiments. Ending the service, entering the final record into distributed ledger 110 and ERP system 116 at 312, 314, and 316 are similar to the process shown in FIG. 3. When ERP system 116 receives notification of the end of service, at 402, ERP system 116 or a similar procurement system creates an invoice for the service. The invoice may include information from the service, the anonymous identity of user 106 used at the service consumption, and also the identity of third party service provider 104. Additionally, third party service provider 104 may combine the invoice with other invoices for the same home service provider 102 in a single invoice and send it as a collective invoice to the home service provider 102. Third party service provider 104 and the home service provider 102 exchange the billing details over distributed ledger 110 so a copy inside the invoice may be done for auditing and process simplifications inside ERP system 116 and billing system 112. Copying the information of the distributed ledger 110 into purchase order of home service provider 102 and invoice of third party service provider 104 may be used because distributed ledger 110 may have not the lifetime legally required e.g. the distributed ledger may be prune old records for data privacy, hardware storage cost and other reasons.

ERP system 116 of third party service provider 104 sends the invoice for the service to home service provider 102. This invoice is sent outside the distributed ledger 110. That is, the invoice is not included on distributed ledger 110 or distributed ledger 110. Third party service provider 104 may determine where to send the invoice using the identity information found in distributed ledger 110 for the anonymous identity. For example, the block for the anonymous user identity may have included the billing company 102 for the anonymous identity of user 106. The invoice from third party service provider 104 may identify third party service provider 104 as the originator of the invoice with the records of the distributed ledger 110 but it is sent outside the distributed ledger 110 primarily to avoid financial regulations to be considered in distributed ledger 110. and also to avoid any transactions fees. Thus, the distributed ledger is not a currency, which would include implementation of complex legal requirements. At 406, home service provider 102 receives the invoice from third party service provider 104 and creates a purchase order for third party service provider 104 if it was not done previously in step 318 of FIG. 3. The received invoice matched one to one with the purchase order is used to authorize payment for the invoice created by third party service provider 104, which may be payment for all the services provided by third party service provider 104 to users associated with home service provider 102. If it is done correctly then the invoices created and sent by third party service provider 104 and the purchase orders created by home service provider 102 match over a certain billing period and therefore the payment can be automatically settled, and no manual checks are need.

At 404, home service provider 102 scans distributed ledger 110 and creates a user invoice, which is then sent to user 106 at 320. Home service provider 102 can map the anonymous identity in distributed ledger 110 to the identity of user 106 using the private mapping inside the system that provides the anonymous identity for the user and therefore keeps the mapping of both. Then, home service provider 102 can invoice user 106. In some embodiments, user 106 may receive a combined bill that combines the direct services from home service provider 102, such as at home location 108, with the charges from third party service providers 104 and services from other third party services providers consumed in a similar way. Home service provider 102 can cross reference the invoice to user 106 to the charges on the invoice received from third party service provider 104 using the anonymous identity. This allows home service provider 102 to clear and settle invoices sent to user 106 with invoices received from third party service provider 104. Furthermore, home service provider 102 can include the single record in the distributed ledger 110 so that the user can verify the outstanding payments and therefore the consumed services at third party service providers.

### CONCLUSION

Accordingly, an open clearing settlement system without intermediaries is provided without transaction fees of intermediaries such as payment service providers and with privacy of the users. For example, distributed ledgers 110 enable anonymous charging records to be recorded with trust, and can be used without transaction fees. A data record summarizing charges may be stored on distributed ledger 110. However, invoicing and billing may be performed outside the distributed ledger 110 to avoid complex financial requirements for the distributed ledger and to avoid transaction fees of intermediaries. Because distributed ledger 110 is exchanged between all parties for example over public network such as Internet, home service provider 102 can scan the records in the distributed ledger 110 to create invoices for user 106 for services provided by third party service providers 104. The scanning of the records in the distributed ledger 110 allows home service provider 102 to provide near-real time billing for user 106 without using intermediaries. Settlement of an invoice outside the distributed ledger for the service to third party service provider 104 may also be provided once receiving an invoice from ERP system 116 respectively an procurement system

System

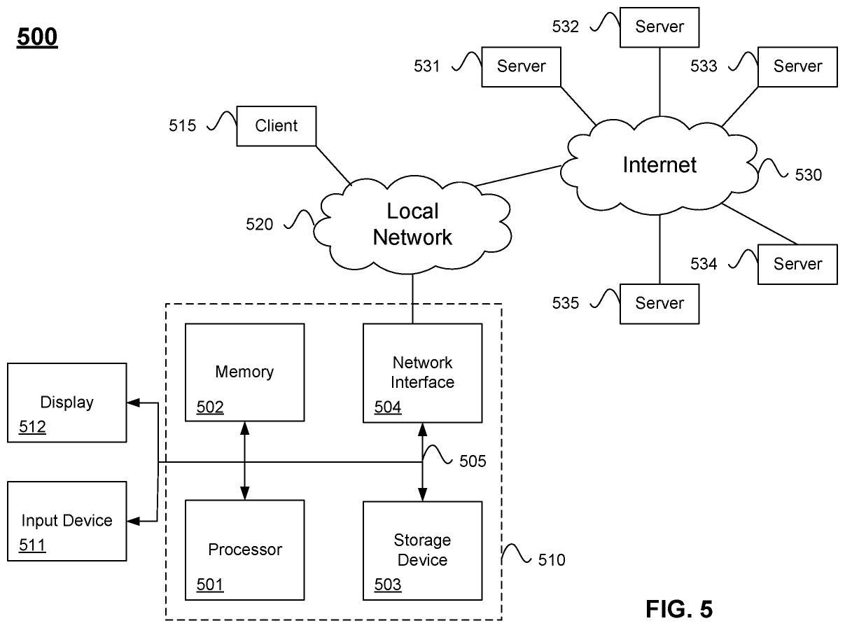

FIG. 5 illustrates hardware of a special purpose computing machine configured with ERP system 112 according to one embodiment. An example computer system 510 is illustrated in FIG. 5. Computer system 510 includes a bus 505 or other communication mechanism for communicating information, and a processor 501 coupled with bus 505 for processing information. Computer system 510 also includes a memory 502 coupled to bus 505 for storing information and instructions to be executed by processor 501, including information and instructions for performing the techniques described above, for example. This memory may also be used for storing variables or other intermediate information during execution of instructions to be executed by processor 501. Possible implementations of this memory may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 503 may include source code, binary code, or software files for performing the techniques above, for example. Storage device and memory are both examples of computer readable storage mediums.

Computer system 510 may be coupled via bus 505 to a display 512, such as a cathode ray tube (CRT) or liquid crystal display (LCD), for displaying information to a computer user. An input device 511 such as a keyboard and/or mouse is coupled to bus 505 for communicating information and command selections from the user to processor 501. The combination of these components allows the user to communicate with the system. In some systems, bus 505 may be divided into multiple specialized buses.

Computer system 510 also includes a network interface 504 coupled with bus 505. Network interface 504 may provide two-way data communication between computer system 510 and the local network 520. The network interface 504 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 504 sends and receives electrical, electromagnetic, or optical signals that carry digital data streams representing various types of information.

Computer system 510 can send and receive information through the network interface 504 across a local network 520, an Intranet, or the Internet 530. In the Internet example, software components or services may reside on multiple different computer systems 510, clients 515, or servers 531-535 across the network. The processes described above may be implemented on one or more servers, for example. A server 531 may transmit actions or messages from one component, through Internet 530, local network 520, and network interface 504 to a component on computer system 510. The software components and processes described above may be implemented on any computer system and send and/or receive information across a network, for example.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured to perform that which is described in some embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A method used by a first service provider for settlement of invoices, the method comprising:
selecting, by a computing device, a record in a distributed ledger indicating that a user used a service offered by a second service provider, wherein the record includes a first user identity for the user;
mapping, by the computing device, the first user identity to a second user identity from a mapping that maps the first user identity to the second user identity;
creating, by the computing device, a first invoice for the second user identity including a first charge for using the service based on information in the record of the distributed ledger;
receiving, by the computing device, a second invoice from the second service provider including a second charge based on the user using the service, the second invoice received outside the distributed ledger and including a service provider identity and the first user identity; and
creating, by the computing device, a purchase order for the second invoice from the second service provider to settle the second charge and the first charge for the user using the service.

2. The method of claim 1, wherein information from the second invoice is not stored on the distributed ledger.

3. The method of claim 1, wherein the second invoice includes all charges for the first service provider that are incurred at the second service provider for the user and other users during a time period.

4. The method of claim 1, wherein the second invoice is correlated to the record in the distributed ledger using the first user identity.

5. The method of claim 1, further comprising:
storing the first user identity in the distributed ledger.

6. The method of claim 5, wherein the mapping of the first user identity to the second user identity is stored at the first service provider.

7. The method of claim 6, wherein the second user identity or the mapping of the first user identity to the second user identity is stored outside of the distributed ledger.

8. The method of claim 5, wherein the storing the first user identity in the distributed ledger comprises:
associating a first service provider identity with the first user identity in the distributed ledger, wherein the second service provider uses the first service provider identity to determine where to send the second invoice.

9. The method of claim 1, further comprising:
creating the first user identity for the user;
registering the first user identity on the distributed ledger; and
providing the first user identity to the user for use in receiving the service.

10. The method of claim 1, wherein selecting the record in the distributed ledger comprises:
scanning the distributed ledger to retrieve the record based on the record including the first user identity.

11. The method of claim 10, wherein scanning is performed automatically by the first service provider without using an intermediary to process invoicing of the service.

12. The method of claim 1, wherein settling the second charge and the first charge comprises:
mapping the first charge to at least a portion of the second charge, wherein the second invoice included charges for multiple services received for users associated with the first service provider.

13. The method of claim 1, further comprising:
validating the record in the distributed ledger using authentication information in the record that is associated with the second service provider.

14. A non-transitory computer-readable storage medium containing instructions, that when executed, control a computer system to be operable for:
selecting a record in a distributed ledger indicating that a user used a service offered by a second service provider, wherein the record includes a first user identity for the user;
mapping the first user identity to a second user identity from a mapping that maps the first user identity to the second user identity;
creating a first invoice for the second user identity including a first charge for using the service based on information in the record of the distributed ledger;
receiving a second invoice from the second service provider including a second charge based on the user using the service, the second invoice received outside the distributed ledger and including a service provider identity and the first user identity; and
creating a purchase order for the second invoice from the second service provider to settle the second charge and the first charge for the user using the service.

15. A method for invoicing at a second service provider, the method comprising:
receiving, by a computing device, a start of a service for a first user identity, wherein the first user identity is associated with a first service provider;
upon completion of the service, by the computing device, storing a record on a distributed ledger for a charge associated with the service, the record including the first user identity;
creating, by the computing device, a first invoice that includes the charge for the service, the first user identity, and a second service provider identity for the second service provider; and
sending, by the computing device, the first invoice to the first service provider, wherein the first service provider retrieves the record from the distributed ledger and sends a second invoice to a user associated with a second user identity that is mapped to the first user identity and also maps the second invoice to a purchase order for the first invoice.

16. The method of claim 15, wherein sending the first invoice comprises:
sending the first invoice separate from the distributed ledger such that information from the first invoice is not stored on the distributed ledger.

17. The method of claim 15, wherein sending the invoice comprises:
sending the invoice directly from the second service provider to the first service provider.

18. The method of claim 15, further comprising:
storing the second service provider identity in the distributed ledger to allow verification of the first invoice.

19. The method of claim 15, further comprising:
storing multiple records in the distributed ledger for the service, the multiple records including incremental charges for the service.

20. The method of claim 15, further comprising:
storing a record in the distributed ledger that indicates an ending of the service, wherein the first service provider invoices the user upon detecting the ending of the service.
